(19) United States
(12) Patent Application Publication
(10) Pub. No.: US 2012/0159066 A1
(43) Pub. Date: Jun. 21, 2012

(54) SYSTEM AND METHOD FOR PERFORMING CONTIGUOUS DISK READ ON PSEUDO-CONTIGUOUS DATA BLOCKS WITHIN A DATABASE MANAGEMENT SYSTEM

(76) Inventors: Sorana Rabinovici, Woodland Hills, CA (US); Suzhen Lin, San Diego, CA (US)

(21) Appl. No.: 12/971,012

(22) Filed: Dec. 17, 2010

(51) Int. Cl. G06F 12/08

(52) U.S. Cl. 711/113; 711/E12.019

(57) ABSTRACT

A system and method to facilitate cache management and improve disk read performance for database systems with large memory and large disks. A contiguous read feature is employed to read multiple pseudo-contiguous data blocks in one large I/O from disk storage into cache memory. The contiguous read feature loads the disk area containing pseudo-contiguous data blocks by issuing a single disk read. A separate virtual space and memory page list is created for each data block, and the page lists are reunited to create one I/O. The pseudo-contiguity of two data blocks is determined by comparing the distance between them, i.e., the size of the hole between the two data blocks, with a predefined maximum distance, over which it is more effective to read the data blocks independently.

### FIELD OF THE INVENTION

The present invention relates to database systems, and in particular to a system and method for facilitating cache management and improving disk read performance for database systems with large memory and large disks.

### BACKGROUND OF THE INVENTION

Within a modern database system, a common data base query is a full file scan, in which the system reads multiple data blocks placed in the same disk vicinity. To improve the performance of retrieving these data blocks, it is desired to read them all in one I/O. A way to accomplish this is to reserve a virtual space large enough to mirror a portion of disk, lock pages behind disk portion, and read all data blocks into the virtual space. The problem with this large read is that it requires more memory than necessary, and as such it uses a precious system resource. It also forces any cache management processes to implement different policies for normal data and the data in the large memory slot, e.g., aging, etc.

Described below is a system and method for performing contiguous disk reads into pseudo-contiguous data blocks, i.e., blocks that are not necessarily contiguous, in sparse virtual memory, with a single read I/O.

### BRIEF DESCRIPTION OF THE DRAWINGS

FIG. 1 illustrates an exemplary software and hardware environment that could be used with the present invention.

FIG. 2 is a block diagram of a parsing engine.

FIG. 3 is a flow diagram of a parser.

FIG. 4 is a flow diagram illustrating a contiguous read process in accordance with the present invention.

FIG. 5 provides an illustration of a list of data blocks requested for preloading, and a sorted list of data blocks organized into small contiguous read chains in accordance with the present invention.

FIG. 6 provides a physical illustration of the contiguous read process illustrated in the flow diagram of FIG. 4.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

### Environment

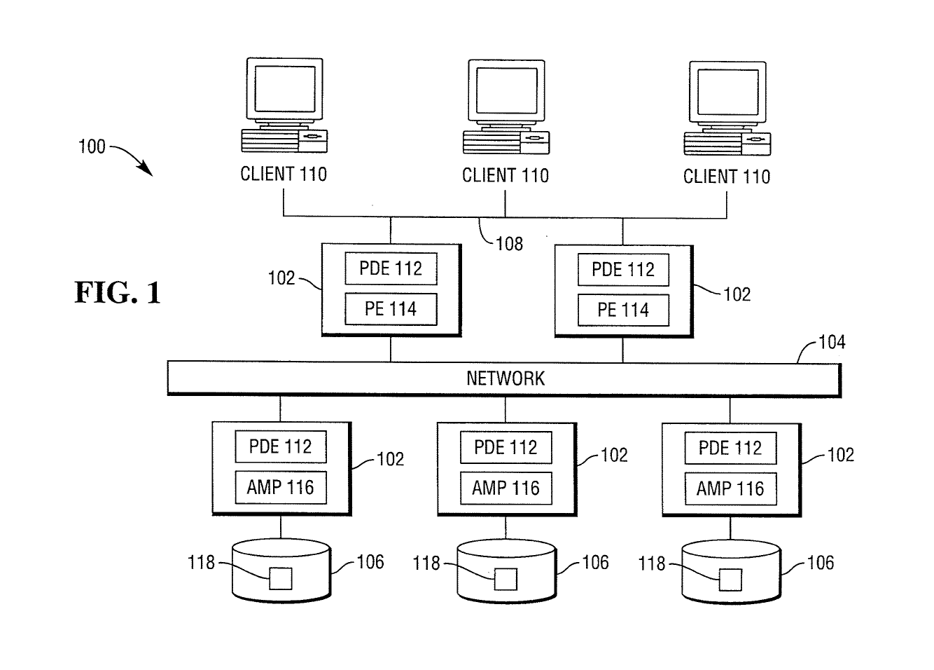

FIG. 1 illustrates an exemplary hardware and software environment that could be used with the present invention. In the exemplary environment, a computer system 100 is comprised of one or more processing units (PUs) 102, also known as processors or nodes, which are interconnected by a network 104. Each of the PUs 102 is coupled to zero or more fixed and/or removable data storage units (DSUs) 106, such as disk drives, that 10 store one or more relational databases. Further, each of the PUs 102 is coupled to zero or more data communications units (DCUs) 108, such as network interfaces, that communicate with one or more remote systems or devices.

Operators of the computer system 100 typically use a workstation 110, terminal, computer, or other input device to interact with the computer system 100. This interaction generally comprises requests or statements that conform to the Structured Query Language (SQL) standard, and invoke functions performed by Relational DataBase Management System (RDBMS) software executed by the system 100. Specifically, the RDBMS software manages data stored as one or more tables in a relational database, wherein a table is two dimensional, comprising rows (tuples) and columns (attributes). Generally, each column is defined by a schema that defines the type of data held in that column. SQL statements may be used to interact with and manipulate the data stored in the tables, including inserting or updating the data and retrieving the data.

In the preferred embodiment of the present invention, the RDBMS software comprises the Teradata® product offered by Teradata Corporation, and includes one or more Parallel Database Extensions (PDEs) 112, Parsing Engines (PEs) 114, and Access Module Processors (AMPs) 116. These components of the RDBMS software perform the functions necessary to implement the RDBMS and SQL, i.e., definition, compilation, interpretation, optimization, database access control, database retrieval, database update, etc.

Work is divided among the PUs 102 in the system 100 by spreading the storage of a partitioned relational database 118 managed by the RDBMS software across multiple AMPs 116 and the DSUs 106 (which are managed by the AMPs 116). Thus, a DSU 106 may store only a subset of rows that comprise a table in the partitioned database 118 and work is managed by the system 100 so that the task of operating on each subset of rows is performed by the AMP 116 managing the DSUs 106 that store the subset of rows.

The PEs 114 handle communications, session control, optimization and query plan generation and control. The PEs 114 fully parallelize all functions among the AMPs 116. As a result, the system of FIG. 1 applies a multiple instruction stream, multiple data stream (MIMD) concurrent processing architecture to implement a relational database management system 100.

Generally, the PDEs 112, PEs 114, and AMPs 116 are tangibly embodied in and/or accessible from a device, media, carrier, etc., such as RAM, ROM, one or more of the DSUs 106, and/or a remote system or device communicating with the computer system 100 via one or more of the DCUs 108. The PDEs 112, PEs 114, and AMPs 116 each comprise instructions and/or data which, when executed, invoked, and/or interpreted by the PUs 102 of the computer system 100, cause the necessary steps or elements of the present invention to be performed.

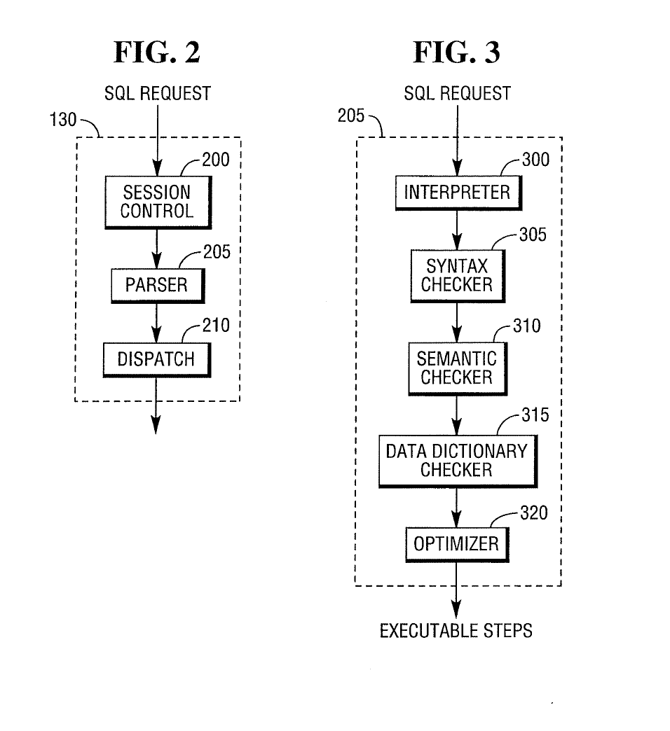

In one example system, the parsing engine 114 is made up of three components: a session control 200, a parser 205, and a dispatcher 210, as shown in FIG. 2. The session control 200 provides the logon and logoff function. It accepts a request for authorization to access the database, verifies it, and then either allows or disallows the access.

Once the session control 200 allows a session to begin, a user may submit a SQL query, which is routed to the parser 205. As illustrated in FIG. 3, the parser 205 interprets the SQL query (block 300), checks it for proper SQL syntax (block 305), evaluates it semantically (block 310), and consults a data dictionary to ensure that all of the objects specified in the SQL query actually exist and that the user has the authority to perform the request (block 315). Finally, the parser 205 runs an optimizer (block 320), which develops the least expensive plan to perform the request and produces executable steps to execute the plan. A dispatcher 210 issues commands to the PDEs 112 and AMPs 116 to implement the executable steps.

A common query processing operation, often used in query optimization, is a full file scan, in which the system reads multiple data blocks placed in the same disk vicinity. Within the Teradata Relation Database system, a cylinder read is a feature that allows the reading of all data blocks that pertain to a particular table within a logical cylinder in one I/O operation. A cylinder read reduces the number of disk reads and, as a result, saves on I/O overhead time and the associated CPU path used to process multiple I/Os. Previously a cylinder was loaded from disk into one of a number of cylindersized (very large) buffers in memory, known as cylinder slots. Cylinder slots were configured in the file segment (FSG) cache during system start/reset.

### Contiguous Read

To facilitate cache management and improve performance for systems with large memory and large disks, a contiguous read feature is employed to read multiple pseudo-contiguous data blocks in one large I/O from disk storage into cache. The contiguous read, also referred to herein as a slotless cylinder read, feature will load the disk area containing pseudo-contiguous data blocks by issuing a single disk read. A separate virtual space and memory page list is created for each data block, and the page lists are reunited to create one I/O. The pseudo-contiguity of two data blocks is determined by comparing the distance between them, i.e., the size of the hole between the two data blocks, with a predefined maximum distance, over which it is more effective to read the data blocks independently. A trash page will be used to DMA the pages of data that do not belong to either of the pseudo-contiguous data blocks.

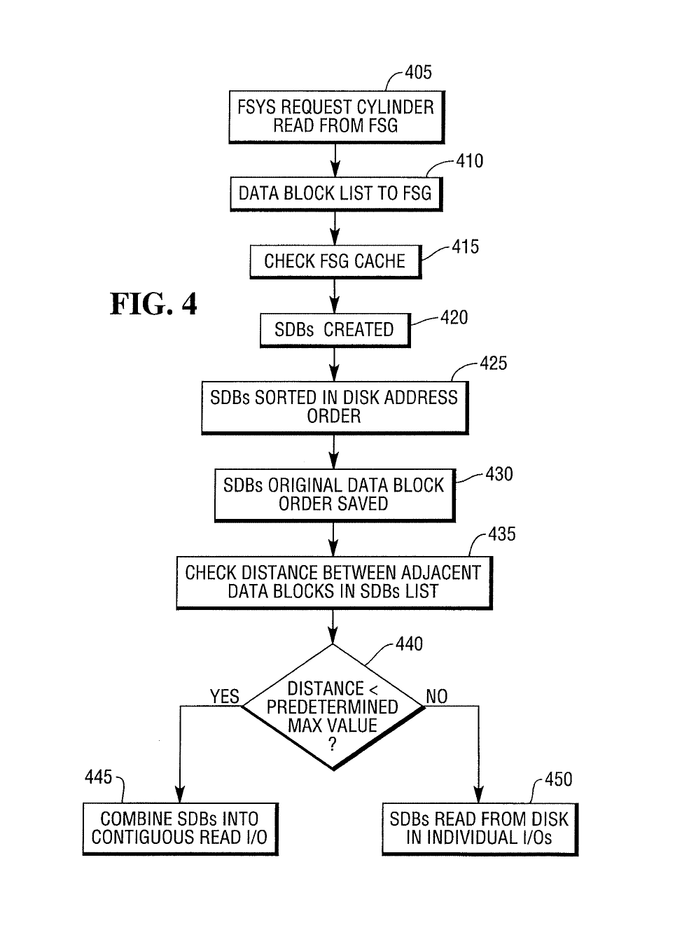

The contiguous read process is illustrated in the flow diagram of FIG. 4. When there is a full file scan type of operation, Teradata file system code (FSYS) will send down to its driver level (FSG driver code) a list of data blocks requested for preloading (steps 405 and 410). The driver code will traverse this list and identify any of the data blocks that are already in FSG cache (step 415). For data blocks that do not exist in the cache, a Segment Descriptor Block (SDB) will be created for each data block (step 420). The new SDBs will be sorted in the data blocks' disk address order (step 425). Another list of these SDBs in the original request order will also be maintained (step 430).

The FSG driver code will walk through the sorted SDBs list and determine if any data blocks can be combined in one read I/O. The FSG driver code will then check if the distance between data blocks adjacent in the SDB list is small enough to be treated as contiguous in disk (step 435). This decision is made by comparing the distance between data blocks with a predetermined maximum distance value, determined through testing and/or experimentation (step 440). The maximum size of the amount of data loaded by a contiguous read cannot exceed a predefined value. This predefined value is set to be the I/O size limitation of the systems. If a certain number of data blocks can be combined into one read I/O (contiguous read I/O), the corresponding SDBs will be removed from the sorted list and linked together into one chain (step 445). For those data blocks that will not be read in contiguous read I/Os, the corresponding SDBs will also be removed from the sorted list and the data blocks will be read from disk one by one (step 450). At the end, the sorted list will be broken into small contiguous read chains or individual SDBs. When a contiguous read is issued, a list of physical pages will be allocated for each SDB in the contiguous read chain.

To respect the order of the data blocks from FSYS, the FSG driver code will walk through the SDB list in the original data block order to trigger contiguous read I/Os or regular I/Os after the contiguous read decision is made based on the sorted SDB list. When there are useless pages between two data blocks read from disk, a trash page is used as recipient of the DMA data transfer. A trash page is allocated for each AMP, and freed at the reset of the system.

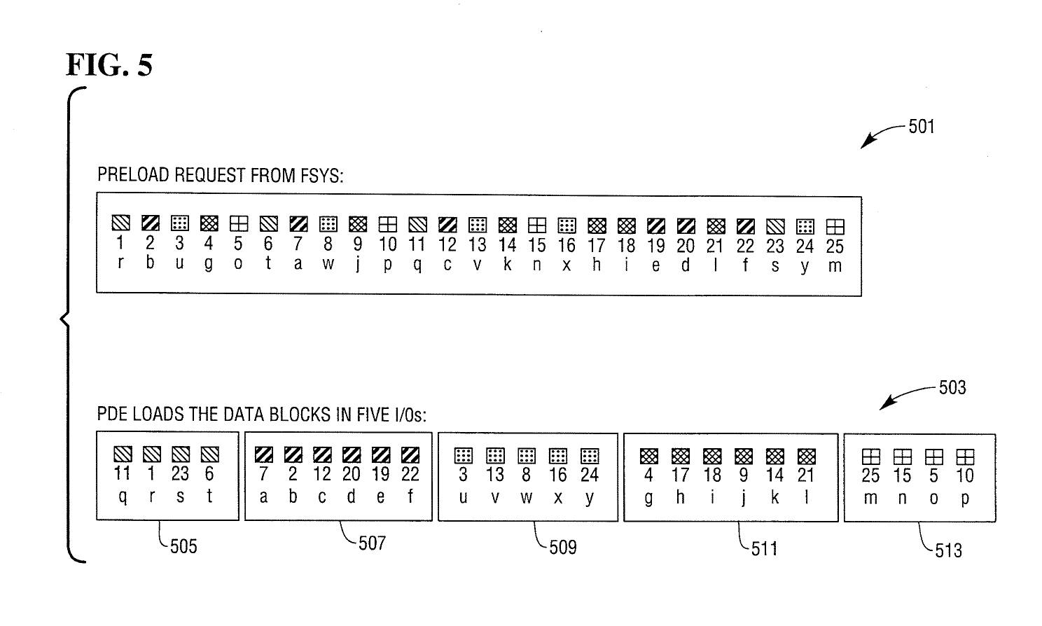

FIG. 5 provides an illustration of a list of data blocks 501 requested for preloading by the Teradata file system code (FSYS), and the sorted list of data blocks 503, organized into small contiguous read chains 505, 507, 509, 511 and 513. A small square denotes a data block, squares with the same pattern, such as blocks 1, 6, 11, and 23, are pseudo-contiguous in disk The numerical order provided below the data blocks represents the logical order of the data blocks passed by FSYS, and the alphabetical order represents the physical order of the data blocks on disk.

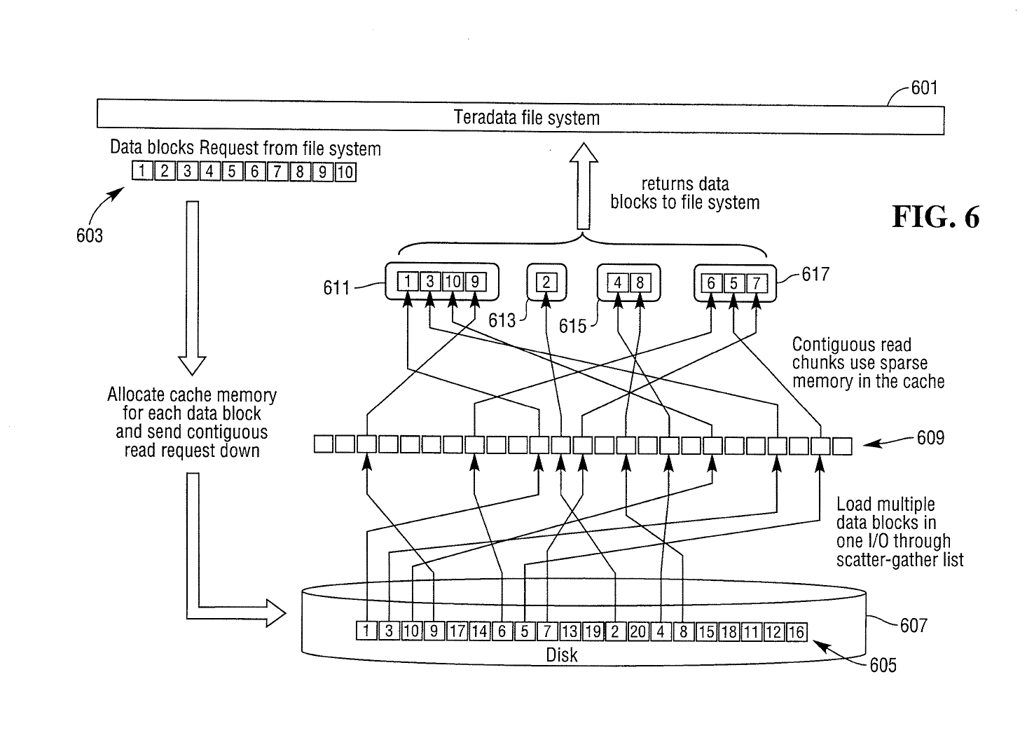

FIG. 6 provides a physical illustration of the contiguous preload, or slotless cylinder read process, discussed above and illustrated in the flow diagram of FIG. 4. Referring to FIG. 6, the file system 601 issues a request for data blocks 603. Cache memory 609 is allocated for each data block and the contiguous request is sent to disk 607. Multiple data blocks 605, including those identified in the initial request from the file system, are loaded from disk 607 to cache memory 609 in one I/O through a scatter-gather list, and the requested data blocks are returned from cache memory to file system 601 in small contiguous read chains 611, 615, and 617 or individual SDBs 613.

### CONCLUSION

The Figures and description of the invention provided above reveal a novel system and method to facilitate cache management and improve disk read performance for database systems with large memory and large disks. With this new feature, pseudo-contiguous data blocks will be read in sparse virtual addresses, without the need for a costly pre-allocated memory slot.

Instructions of the various software routines discussed herein, such as the method illustrated in FIG. 4, are stored on one or more storage modules in the system shown in FIG. 1 and loaded for execution on corresponding control units or processors. The control units or processors include microprocessors, microcontrollers, processor modules or subsystems, or other control or computing devices. As used here, a “controller” refers to hardware, software, or a combination thereof. A “controller” can refer to a single component or to plural components, whether software or hardware.

Data and instructions of the various software routines are stored in respective storage modules, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines are loaded or transported to each device or system in one of many different ways. For example, code segments including instructions stored on floppy disks, CD or DVD media, a hard disk, or transported through a network interface card, modem, or other interface device are loaded into the device or system and executed as corresponding software modules or layers.

The foregoing description of various embodiments of the invention has been presented for purposes of illustration and description. It is not intended to be exhaustive or to limit the invention to the precise form disclosed. Many alternatives, modifications, and variations will be apparent to those skilled in the art in light of the above teaching.

What is claimed is:

1. A computer-implemented method for optimizing disk read performance for database systems, the method comprising the steps of:
providing to a computer a list of data blocks to be read from a disk storage device;
creating, by said computer, a Segment Descriptor Block (SDB) for each data block to be read from said disk storage device;
creating, by said computer, a SDB list comprising said SDBs sorted in their associated data blocks disk address order;
determining, by said computer, the distance between adjacent data blocks in the SDB list;
comparing, by said computer, the distance between data blocks in the SDB list with a predetermined maximum; and
combining, by said computer, adjacent data blocks in the SDB list with a distance between the adjacent data blocks less than said predetermined maximum into a pseudo-contiguous read chain; and
reading, by said computer, from said disk storage device data within an area containing said pseudo-contiguous read chain in a single read operation.

2. The computer-implemented method for optimizing disk read performance for database systems in accordance with claim 1, further comprising the step of:
writing, by said computer, the data read from the area of said disk drive storage device containing said pseudo-contiguous read chain to a cache memory.

3. A system for optimizing disk read performance for database systems, the system comprising:
a disk storage device; and
a computer for:
receiving a list of data blocks to be read from said disk storage device;
creating a Segment Descriptor Block (SDB) for each data block to be read from said disk storage device;
creating a SDB list comprising said SDBs sorted in their associated data blocks disk address order;
determining the distance between adjacent data blocks in the SDB list;
comparing the distance between data blocks in the SDB list with a predetermined maximum; and
combining adjacent data blocks in the SDB list with a distance between the adjacent data blocks less than said predetermined maximum into a pseudo-contiguous read chain; and
reading from said disk storage device data within an area containing said pseudo-contiguous read chain in a single read operation.

4. The system for optimizing disk read performance for database systems in accordance with claim 3, wherein:
said system further comprises a cache memory; and
said computer writes the data read from the area of said disk drive storage device containing said pseudo-contiguous read chain to said cache memory.

5. A computer program, stored on a tangible storage medium, for optimizing disk read performance for database systems, the program including executable instructions that cause a computer to:
receive a list of data blocks to be read from a disk storage device;
create a Segment Descriptor Block (SDB) for each data block to be read from said disk storage device;
creating a SDB list comprising said SDBs sorted in their associated data blocks disk address order;
determine the distance between adjacent data blocks in the SDB list;
compare the distance between data blocks in the SDB list with a predetermined maximum; and
combine adjacent data blocks in the SDB list with a distance between the adjacent data blocks less than said predetermined maximum into a pseudo-contiguous read chain; and
read from said disk storage device data within an area containing said pseudo-contiguous read chain in a single read operation.

6. The computer program, stored on a tangible storage medium, in accordance with claim 5, wherein said executable instructions cause said computer to:
write the data read from the area of said disk drive storage device containing said pseudo-contiguous read chain to a cache memory.
